(19) United States
(12) Patent Application Publication
(10) Pub. No.: US 2011/0090234 A1
(43) Pub. Date: Apr. 21, 2011

(54) APPARATUS AND METHOD FOR CONTROL OF MULTIPLE DISPLAYS FROM A SINGLE VIRTUAL FRAME BUFFER

(75) Inventors: DAVID BOLCSFOLDI, Vancouver (CA); David Mandelbaum, New York, NY (US); Pieter Truter, Vancouver (CA)

(73) Assignee: Barnes & Noble, Inc., New York, NY (US)

(21) Appl. No.: 12/906,933

(22) Filed: Oct. 18, 2010

Related U.S. Application Data
(60) Provisional application No. 61/252,817, filed on Oct. 19, 2009.
(60) Provisional application No. 61/253,447, filed on Oct. 20, 2009.

(51) Int. Cl. G06F 13/00

(52) U.S. Cl. 345/536

(57) ABSTRACT

A system and process for controlling multiple displays from a single graphical stack. Frame data is written to a single virtual frame buffer from a single graphical stack. The frame data is subsequently displaced from the virtual frame buffer to a plurality of display buffers. In this manner, a plurality of displays are updated. The system and process can operate with displays with different display technologies, such as an electronic paper display and a Liquid Crystal Display (LCD).

### CROSS-REFERENCE TO RELATED APPLICATION

This application claims the benefit of U.S. Provisional Application No. 61/252,817, filed Oct. 19, 2009, and U.S. Provisional Application No. 61/253,447, filed Oct. 20, 2009, which are hereby incorporated by reference.

### FIELD OF INVENTION

The present patent document relates to the field of graphical display processing and, in particular, to the use of a single virtual frame buffer for graphical display processing targeted to multiple, disparate physical displays.

### BACKGROUND OF THE INVENTION

The electronics we use today, in particular the mobile gadgets we carry with us, are expanding to include more and more functionality. Incorporating more functionality into an electronic device often creates an increased demand for shared resources, increased design complexity, and increased costs.

One example of a way to increase functionality in a device is to add more than one display or screen to the device. An additional display may be a desirable component to a device for a number of reasons. For example, numerous new display technologies offer advantages that cannot be duplicated by displays that use other technologies. Thus, by providing disparate displays, a user of the device may benefit from the advantages of both types of technology.

One such example is the recent improvements in displays based on reflective technologies such as electronic paper displays (EPDs). Displays based on reflective technologies offer advantages that cannot be duplicated by displays that are backlit such as liquid crystal displays (LCD). For example, EPDs may be easily viewed in the presence of large amounts of ambient light such as sunlight and are less tiring on the eyes after extensive viewing.

While EPDs offer advantages that cannot be replicated by backlit displays such as LCDs, backlit displays have advantages of their own. For example, backlit displays incorporate color easily and can support higher refresh rates. A higher refresh rate eliminates the stuttering and jerking that is present when watching motion video on screens with low refresh rates such as EPDs. Furthermore, unlike EPDs, backlit displays may be easily modified into touch sensitive displays.

While the addition of displays may add functionality to a device, implementing multiple displays into a device creates numerous problems. Supporting an additional display may be extremely data intensive and thus adding a display may require large amounts of additional memory. In addition to memory, additional displays will compete for other shared resources such as central processing unit (CPU) clock cycles. The extra usage of the shared resources by the additional displays may reduce the performance of the device.

Furthermore, additional displays on the same device, especially additional disparate displays, create problems with implementation to standard software applications. Device manufacturers often do not create completely custom software to run on their devices and instead often use existing mobile operating systems such as Windows Mobile® or Android®.

One downside to using an existing operating system is that the software architecture will be limited by the application programmers interface (API) of the operating system. In particular with respect to a display, the graphical stack of existing operating systems is designed to drive a single display and to update a single display buffer. While it may be possible to instantiate separate graphical stacks for each display, having more than one graphical stack may increase the use of shared resources, impact system performance, and increase the complexity of higher level software architecture.

### BRIEF SUMMARY OF THE INVENTION

In view of the foregoing, an object according to one aspect of the present patent document is to provide an improved apparatus and process for controlling multiple displays from a single virtual frame buffer. Preferably the apparatus and processes address, or at least ameliorate one or more of the problems described above. To this end, a process for controlling multiple displays from a single graphical stack is provided; the process comprising the acts of: writing a frame data to a single virtual frame buffer from a single graphical stack; displacing the frame data from the single virtual frame buffer to a plurality of display buffers and updating a plurality of displays.

In another aspect, a first display of a plurality of displays uses a disparate display technology from a second display of the plurality of displays. In one aspect, the first display is an electronic paper display. In a further aspect, a second display is a liquid crystal display.

In yet another aspect, the process performs the additional act of calling a hook function. In one such aspect, the hook function is a hardware acceleration hook function. The hardware acceleration hook function may set a flag indicating at least one display of the plurality of displays does not need updating. In another aspect, the hardware acceleration hook function uses a hardware accelerator to render the frame data received from the graphical stack directly into a display buffer.

In another aspect, the process further includes the act of checking a flag to determine whether the frame data is intended to update a first display of the plurality of displays prior to displacing the frame data from the virtual frame buffer to a display buffer.

In another aspect, an electronic device is provided; the electronic device comprises, a first display coupled to the electronic device and a second display coupled to the electronic device, wherein the electronic device is configured to run the first display and the second display from a single graphical stack and a single virtual frame buffer. In one aspect, the electronic device is a hand-held portable device. In another aspect, the electronic device further comprises a first display buffer and a second display buffer associated with their respective displays.

In another aspect, the first display uses a disparate display technology from the second display. In a further aspect, the first display of the electronic device is an electronic paper display. In another further aspect, the second display is a liquid crystal display.

In yet another aspect, the electronic device is further configured to call a hook function. In one aspect, the hook function is a hardware acceleration hook function. In another aspect, the hardware acceleration hook function is configured to set a flag indicating the first display does not need updating.

In another aspect, the electronic device further comprises a hardware accelerator. A hardware acceleration hook function may be configured to use the hardware accelerator to render frame data received from the graphical stack directly into a display buffer.

In another aspect, the electronic device is further configured to check a flag to determine whether frame data is intended to update the first display prior to displacing the frame data from the virtual frame buffer into a display buffer.

### BRIEF DESCRIPTION OF DRAWINGS

FIG. 1 illustrates the relationships of the various hardware and software components of one exemplary aspect of a multi-display device.

FIG. 2 illustrates a block diagram of an aspect of a multi-display device including multiple displays being supported by a single graphical stack.

FIG. 3 illustrates a conceptual block diagram representation of a first exemplary aspect of a method for optimizing control of two graphical displays receiving changes from a single a virtual frame buffer;

FIG. 4 illustrates a conceptual block diagram representation of a first exemplary aspect of a method for optimizing control of two graphical displays where the single virtual frame buffer is bypassed to process changes for one graphical display;

FIG. 5 illustrates a conceptual block diagram representation of a first exemplary aspect of a method for optimizing control of two graphical displays where only one graphical display requires changes and the other graphical display remains unchanged; and

FIG. 6 illustrates a conceptual block diagram representation of a second exemplary aspect of a method for optimizing control of two graphical displays where a single virtual frame buffer is constructed with a front buffer and back buffer.

### DETAILED DESCRIPTION

Consistent with its ordinary meaning, the term “virtual frame buffer” is used herein to refer to a section of memory used for storing image data. The virtual frame buffer includes information for the pixels of a display. The pixel information may include, location, color, brightness, or any other pixel quality. The virtual frame buffer is typically implemented to abstract access to the physical frame buffer but may be used for any other reason. By way of non-limiting example, “virtual frame buffers” include buffers such as the Linux frame buffer fbdev and the X Windows frame buffer Xvfb.

A manufacturer may want to add an additional display to a device that is based on a disparate technology from any of the existing displays to increase the functionality of the device. While device manufacturers may integrate additional displays into device hardware, software architectures need to be changed in order to support the additional display. Further complicating the need to update the software architecture is the fact that many hardware manufactures do not control the software operating systems that run their devices but instead choose operating systems or other embedded software developed by third parties.

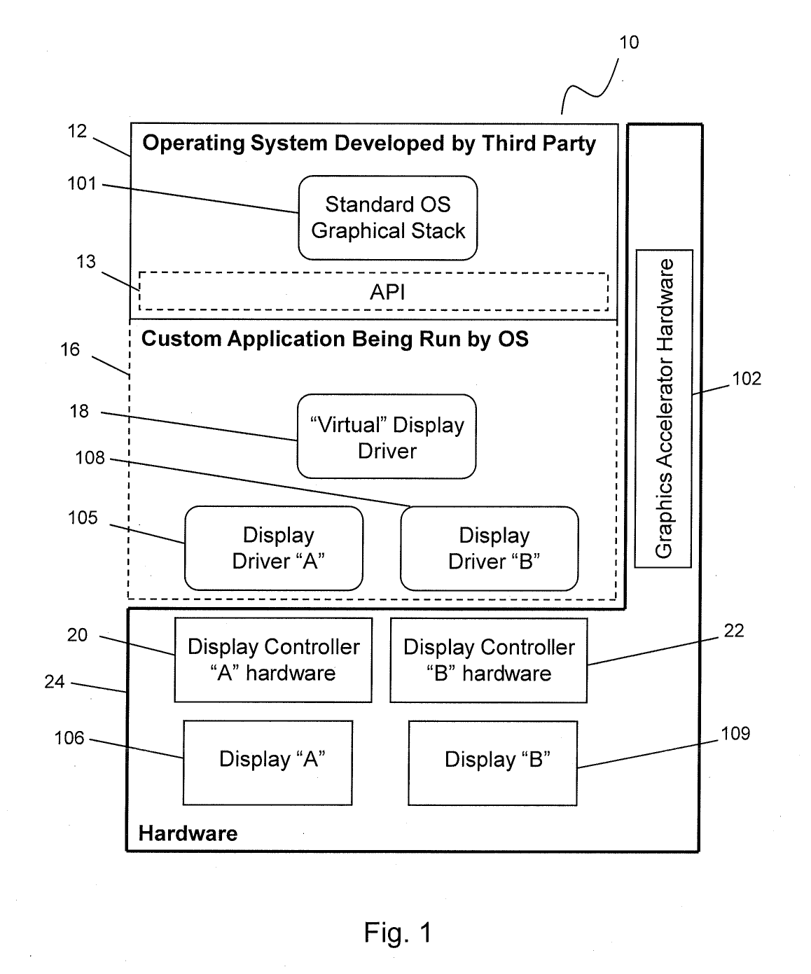

FIG. 1 illustrates the relationships of the various hardware and software components of one exemplary embodiment of a multi-display device. An electronic device with embedded software typically consists of an operating system 12, custom software 16 being run by the operating system 12, and hardware 24.

The custom software 16 may include any number of custom applications for use on the device. As just one example, the custom application may provide the ability to interpret and display ebooks. Similarly, the custom software 16 may include any number of custom drivers to support the hardware 24. For example, the custom software 16 may further include virtual display driver 18, display driver 105 to support a first display (Display “A”) and display driver 108 to support a second display (Display “B”).

Similar to the custom software 16, the hardware 24 is also unique to the device and may consist of any type of hardware. In particular with respect to certain embodiments of the present patent document, the hardware 24 includes a first display 106 (Display “A”) and a second display 109 (Display “B”). Each display device may have a corresponding display controller 20 and 22. The display controllers 20 and 22 are the hardware interface to the display drivers 105 and 108 of the software.

In addition, the hardware 24 may include graphics accelerator hardware 102. Graphics accelerator hardware 102 is any type of hardware designed to allow specialized processing of graphics information. Typically, graphics accelerator hardware 102 includes an additional central processing unit(s) CPU(s) or specialized processing unit(s) specific to graphics. However in other embodiments, no graphics accelerator hardware 102 may be present.

The operating system 12 is often not developed by the hardware manufacturers and many hardware manufacturers use operating systems 12 or other embedded software developed by third parties. Operating systems 12 developed by third parties and designed to run on numerous types of devices may be referred to as universal multi-platform mobile operating systems. Examples of universal multi-platform operating systems include Windows Mobile®, Linux, or Android®, to name a few.

An application programmers interface (API) 13 resides as an interface between the operating system 12 and any custom application 16 specific to the device that is run by the operating system 12. Manufacturers are limited in their access to the architecture of the third-party embedded software to what is available through the API 13. The third-party software is usually provided in an already compiled binary format. Manufacturers using embedded software provided by a third-party on their device face a particular problem with respect to supporting multiple displays. The graphical stack 101 of existing universal multi-platform mobile operating systems is designed to write into a single display buffer. Thus, without the teachings of the present invention, a separate graphical stack 101 is required for each display 106 and 109 on a device.

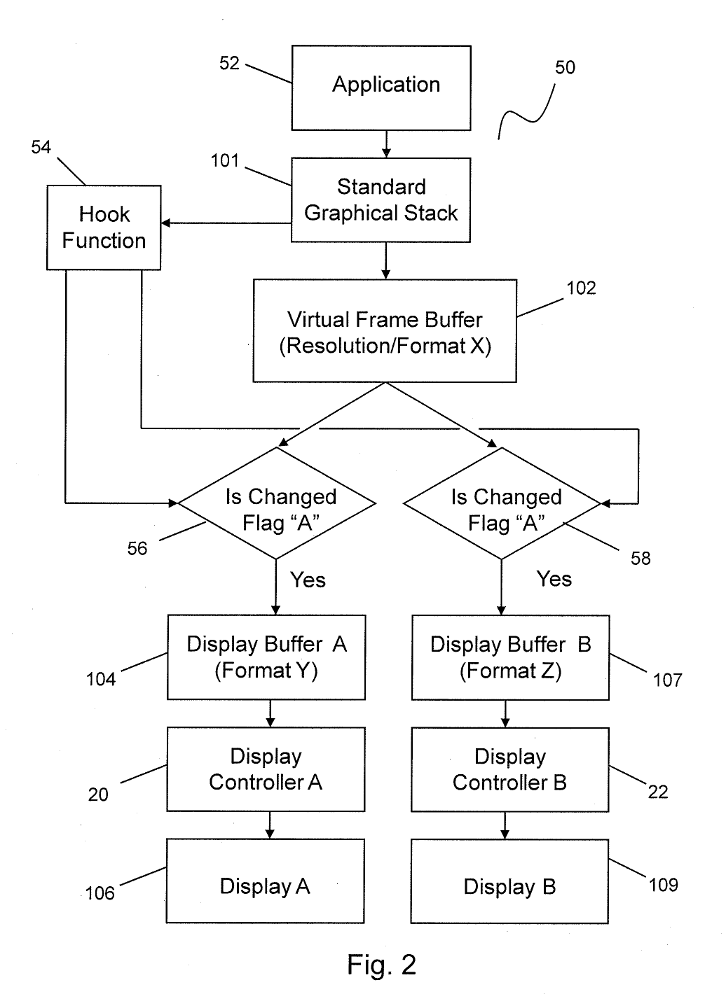

FIG. 1 illustrates one aspect of a new and improved apparatus and processes for control of multiple displays from a single virtual frame buffer. FIG. 2 illustrates a block diagram for an aspect of a multi-display device 50 including multiple displays 106 and 109 being supported by a single graphical stack 101. By creating a single virtual frame buffer 102 and inserting the virtual frame buffer 102 between the graphical stack 101 and the display buffers 104 and 107 of the individual displays 106 and 109, a single graphical stack 101 in a universal multi-platform operating system may drive multiple displays 106 and 109.

The method optimizes graphics processing into multiple physical displays 106 and 109 that may be based on different technologies. A single virtual frame buffer 102 is constructed in memory to accommodate graphics data for two or more physical displays 106 and 109. The single virtual frame buffer 102 resides between the graphical stack and the multiple displays and masks the multiple displays from the upper level software. The single virtual frame buffer allows multiple disparate displays 106 and 109 to be run from a single graphical stack 101 and thus simplifies the upper level software architecture and reduces the required system resources.

Once the virtual frame buffer 102 is inserted between the graphical stack 101 and the display buffers 104 and 107 of the individual displays 106 and 109, numerous additional optimizations may be added. In particular, the present patent document teaches apparatus and processes for optimizing the processing of graphics data onto multiple physical displays 106 and 109 using a single virtual frame buffer 102 and a graphics hardware acceleration hook function 54.

The hook function 54, also sometimes referred to as a callback function, is a function called by the graphical stack 101 when the graphical stack 101 detects an update to the display is needed. Hook functions 54 are common programming components and already available as part of the standard graphical stacks 101 encoded in universal multi-platform operating systems and other embedded software designed to operate displays. Although hook functions 54 are called by the graphical stack 101, hook functions 54 may be coded and compiled by third parties. Because hook functions 54 are executed by the graphical stack 101 of universal multi-platform operating systems, yet may be programmed by manufacturers implementing the graphical stack 101, hook functions 54 may be used to customize standard software to allow the single virtual frame buffer 102 to better support multiple displays 106 and 109.

In a preferred embodiment, the hook function 54 is passed information about the update to the virtual buffer 102 from the graphical stack 101. This information may be used to more efficiently update the multiple displays 106 and 109 that are linked to the single virtual frame buffer 102. For example, if the hook function 54 receives information about what portion of the virtual frame buffer 102 was updated, and that information indicates only a portion of the virtual display buffer 102 corresponding to a particular display was updated, only that particular display needs to be subsequently updated. Without the use of the hook function 54, every display would have to be updated every time the single virtual frame buffer 102 was updated regardless of whether any change in that particular display occurred.

In a preferred embodiment, the hook function 54 is called prior to the graphical stack 101 rendering data into the virtual frame buffer 102. A hook function 54 that is called prior to the graphical stack rendering data into the virtual frame buffer 102 provides more flexibility for handling the frame data. However, the hook function 54 may also be called after the virtual frame buffer 102 is updated. When the hook function 54 is called will depend on what particular hook function 54 is used and how it is implemented in the graphical stack 101 by the embedded software designer. To this end, a graphics acceleration hook function is preferred, however, any hook function 54 provided by the graphical stack 101 may be used.

In a preferred exemplary embodiment, the graphics acceleration hook function 54 is called just prior to rendering into a single virtual frame buffer 102 by the graphical stack 101. The graphics hardware acceleration hook function 54 captures (is passed) rendering parameters and sets flag(s) 56 and/or 58 to indicate whether or not a specified region requires changes. The flag(s) 56 and/or 58 for the specified region indicate(s) whether or not changes exist between the current frame and the next frame targeted to one of the physical displays. When the flag(s) 56 and/or 58 indicate(s) changes exist and rendering for the next frame is complete, the device driver for the display is called or activated and the physical display is updated. When the flag(s) 56 and/or 58 for the specified region(s) indicate(s) no changes, there is no rendering required for the frame and the physical display(s) remain(s) unchanged. Setting the flag(s) with the hook function 54 substantially reduces processing overhead and time delay in updating multiple displays 106 and 109 based on disparate technologies. Furthermore, it allows multiple disparate displays 106 and 109 to be run by a single graphical stack 101 in an efficient manner.

The techniques of the present invention allow standard library binary code for a graphical stack 101, for example the binary code for a graphical stack of a universal multi-platform mobile operating system used by numerous hardware manufacturers, to treat multiple displays as a single display device. The optimized customization for individual disparate displays may be included in the underlying driver software.

One advantage of the embodiments taught herein, is that the higher level applications in a system, e.g. the graphical stack 101, do not have to know the lower level details (e.g. processing requirement) of the physical displays. This is sometimes referred to as hardware abstraction. Accordingly, the graphical stack 101 is able to perform its processing into the single virtual frame buffer 102 without any concern for how the data is eventually processed for the particular display hardware. In this manner, the processing for the two displays 106 and 109 may be optimized. As mentioned above, abstraction has numerous advantages including a simplified upper level software architecture and more efficient use of system resources, to name a few.

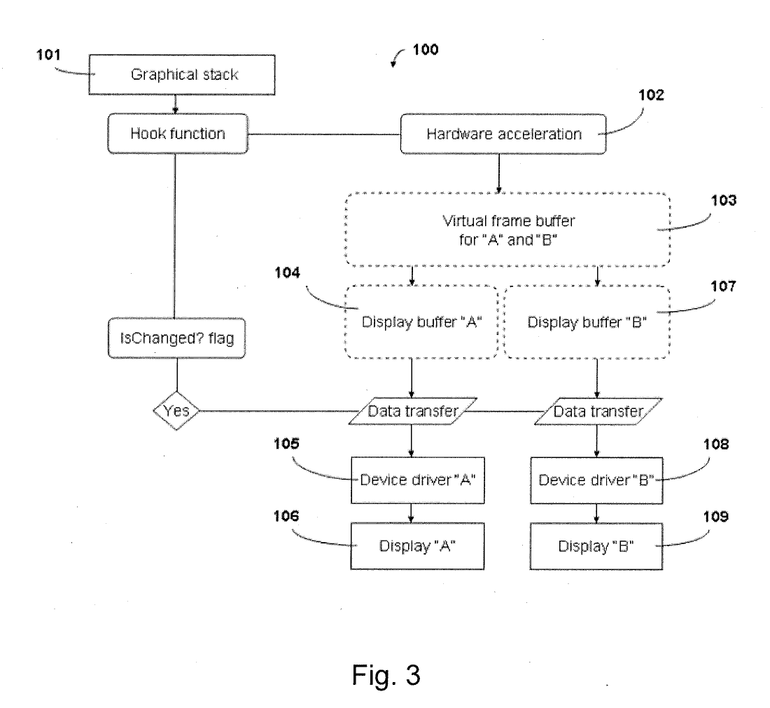

FIG. 3 illustrates a conceptual block diagram representation 100 of an embodiment of a system and method for optimizing control of physical display 106 and physical display 109. In this aspect of the invention, physical display 106 employs a different display technology from physical display 109. For example, physical display 106 could be an Electronic Paper Display (EPD) and physical display 109 could be a Liquid Crystal Display (LCD).

Graphical stack 101 processes graphical data for output to physical display 106 and physical display 107. As shown in FIG. 3 and preferably, a hardware accelerator 102, which may be any additional processing unit in addition to the main central processing unit (CPU), may be used to render data from the graphical stack into the virtual frame buffer. However, a hardware accelerator 102 is not required and the main CPU could perform the rendering from the graphical stack directly into the virtual frame buffer 103. Furthermore, despite the lack of a hardware accelerator 102, the hardware accelerator hook functions in the graphical stack may still be used to optimize data handling from the virtual frame buffer 103 to the physical displays 106, 109.

In FIG. 3, on behalf of a calling application, graphical stack 101 attempts to render graphical data into the virtual frame buffer 103. When a graphical operation is required such as a Bit-Block Image Transfer (BLIT) or other graphical operation, the graphical stack 101 invokes a hook function to permit hardware acceleration 102 to perform the operation. Invoking a hook function is a standard interface to the library of a graphical stack's binary code. The hook function is provided for customization to different hardware acceleration and may be present in the standard embedded software regardless of whether the hardware includes a graphical accelerator. In operation, the hook function captures render parameters from graphical stack 101 and uses hardware acceleration 102 to render graphics data. In the embodiments disclosed herein, the hook function may also set a flag to indicate whether or not a specified region requires changes. Individual flag settings for specified regions indicate whether or not physical display 106 is the destination of updates rendered in virtual frame buffer 103. Similarly, individual flag settings for specified regions also indicate whether or not physical display 109 is the destination of updates rendered in virtual frame buffer 103. Based on the intended destination address of a graphical operation, a virtual display driver determines whether physical display 106 or physical display 109 is the intended target. If no update is required the device driver may exit.

In the embodiment of FIG. 3, the device drivers check the flags set by the hook functions. However, in another exemplary embodiment, the update flags for each display are evaluated by the software prior to calling the device driver. In such an embodiment, if no updates are required for a particular display, the device driver for that display is never executed.

As shown in FIG. 3, hardware accelerator 102 uses its graphics processor to take source data from graphical stack 101 and render the data into a single virtual frame buffer 103. Because the displays 106, 109 may use different display technologies, additional processing may be required on the data in the virtual frame buffer 103 to process it specifically for each of the different physical displays 106, 109. In the embodiment shown in FIG. 3, additional data conversions or graphical transformations required by the underlying display technology of physical display 106 may be done between the virtual display buffer 103 and display buffer 104 by the device driver 105. Similarly, additional data conversions or graphical transformations required by the underlying display technology of physical display 109 are output to display buffer 107 by device driver 108.

As discussed above, additional transformations that are uniquely required by the underlying display technology of physical display 106 may be performed. Such transformations, for example, may include scaling, rotation, color conversion, and displacement into a disparate underlying display buffer 104. Likewise, additional transformations that are uniquely required by the underlying display technology of physical display 109 may be performed and may include displacement into a disparate underlying display buffer 107. When graphical stack 101 indicates that rendering is complete, flags are checked and device driver 105 transfers data to physical display 106 and device driver 108 transfers data to physical display 109.

The separate display buffers 104 and 107 comprise the span of single virtual frame buffer 103 so that all the raw frame data needed for both display buffer 104 and 107 is contained within virtual frame buffer 103. In one exemplary embodiment, the image on display 109 is a portion of the image on display 106. In such an embodiment, display 109 may be a zoom window or other manipulation of a portion of display 106. However, one of the displays is not required to be a portion of the other and each display may contain completely different images.

Once the display buffers 104, 106 have been updated, the device drivers 105, 108 update the physical displays 106, 109. As shown in FIG. 3, device driver 105 transfers data provided in display buffer 104 to physical display 106. Similarly, device driver 108 transfers data provided in display buffer 107 to physical display 109.

The embodiment of the invention is not intended to be limited to two graphical displays with different underlying technologies, as illustrated in FIGS. 3, 4, and 5. There may be more than two graphical displays with different underlying technologies in the embodiments of the present invention.

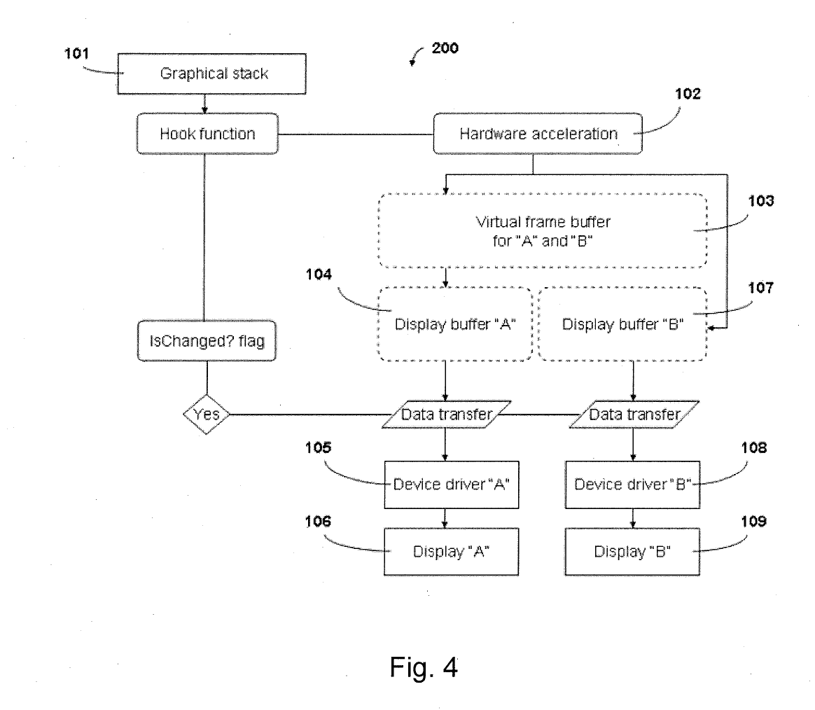

FIG. 4 is similar to FIG. 3 except a hook function of hardware acceleration 102 bypasses virtual frame buffer 103 to perform a graphical operation. The graphical operation is a transformation that is rendered directly into display buffer 107. In this case, a virtual display driver of graphical stack 101 determines that the intended destination of a transformation is physical display 109. The hook function bypasses virtual frame buffer 103 and uses hardware acceleration 102 to perform a transformation based on the underlying display technology requirements of physical display 109. The output of the transformation is rendered directly into display buffer 107. When graphical stack 101 indicates that rendering is complete, flags are checked and device driver 108 transfers data from display buffer 107 to physical display 109. Similarly, updates can be written directly into display buffer 104 for transference of data by device driver 105 to physical display 106.

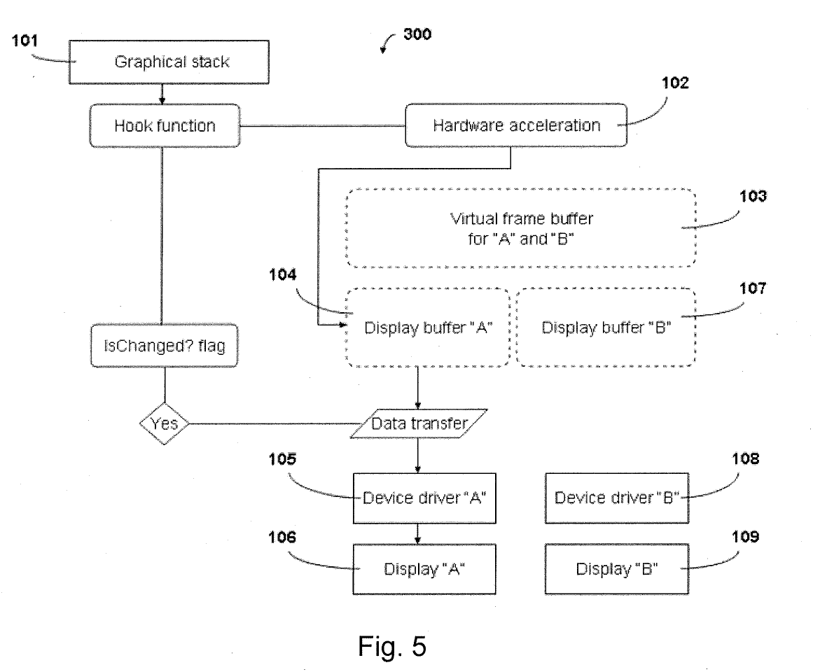

FIG. 5 is similar to FIG. 4 except the flags set by the hook function of hardware acceleration 102 indicate that there are no changes at all targeted to physical display 109. Because there are only changes targeted to physical display 106, graphics processing only needs to be performed for physical display 106. The hook function may bypass virtual frame buffer 103 and use hardware acceleration 102 to perform graphical operations based on the underlying display technology requirements of physical display 106. The graphics processing output is rendered directly into display buffer 104. When graphical stack 101 indicates that rendering is complete, flags are checked and device driver 105 transfers data from display buffer 104 to physical display 106. Since there are no changes targeted for physical display 109, no data needs to be processed or transferred to physical display 109.

Similarly, if there are only changes targeted to physical display 109, graphics processing only needs to be performed for physical display 109. The hook function may bypass virtual frame buffer 103 and use hardware acceleration 102 to perform graphical operations based on the underlying display technology requirements of physical display 109. The graphics processing output is rendered directly into display buffer 107. When graphical stack 101 indicates that rendering is complete, flags are checked and device driver 108 transfers data from display buffer 107 to physical display 109. Since there are no changes targeted for physical display 106, no data needs to be processed or transferred to physical display 106.

FIGS. 4 and 5 are further optimizations of the process described in FIG. 3 in which a hook function is used to optimize the transfer of the display data from the virtual buffer to the displays. As noted above, the optimizations provided by the use of a hook function are not required, however, if a hook function is used for optimization, any number of optimizations are possible. In addition to the optimizations shown in FIGS. 4 and 5, other optimizations are possible. For example, a hook function could be used in combination with the hardware accelerator to directly update display buffers for all the displays thus completely skipping over the virtual frame buffer all together. In general, any optimizations that better handle the data transfer from the single graphical stack to the plurality of displays may be incorporated into one or more hook functions.

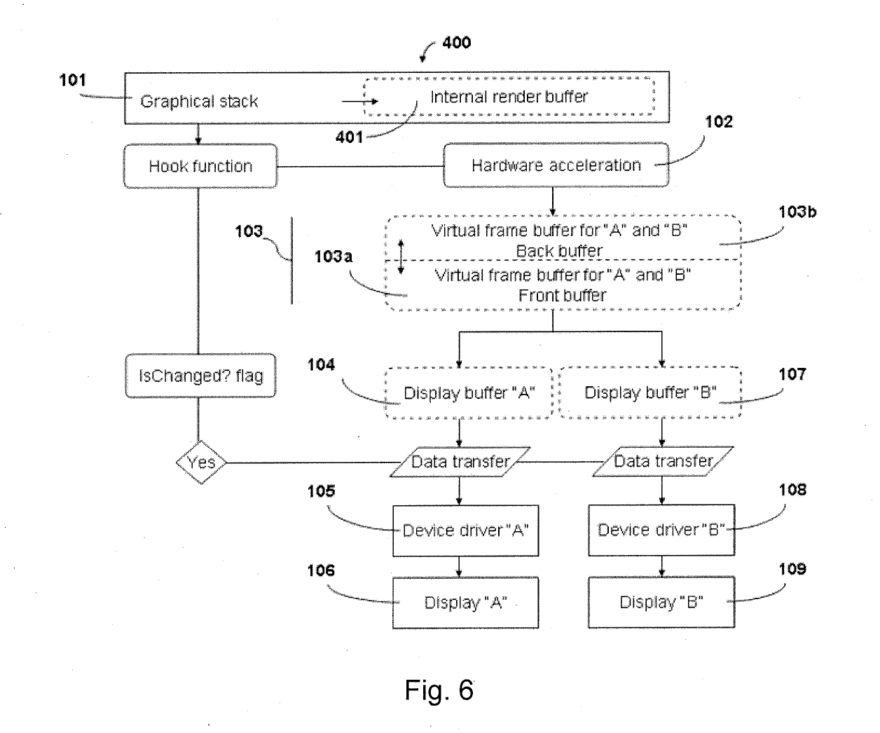

FIG. 6 shows conceptual block diagram representation 400 of an embodiment of a method for optimizing control of physical display 106 and physical display 109 using a double buffering technique in single virtual frame buffer 103. Graphical stack 101 processes graphical data into an internal render buffer 401. A single virtual frame buffer 103 is comprised of front buffer 103a and back buffer 103b. The separate display buffers 104 and 107 comprise the span of front buffer 103a. The separate display buffers 104 and 107 also comprise the span of back buffer 103b.

This exemplary embodiment is not intended to be limited to one back buffer and more than one back buffer may be used. The other parts of FIG. 6 are the same as those in FIGS. 3, 4, and 5 described above.

In the embodiment of FIG. 6, on behalf of a calling application, graphical stack 101 renders graphical data into a single internal render buffer 401. Graphical stack 101 then performs a BLIT operation to copy data from internal render buffer 401 to back buffer 103b in single virtual frame buffer 103. Hardware acceleration 102 captures the BLIT operation. A hook function of hardware acceleration 102 captures which display portion has updates. Upon a signal from graphical stack 101 that the BLIT transfer of graphical data from internal render buffer 401 to back buffer 103b is complete, virtual frame buffer 103 swaps front buffer 103a with back buffer 103b by changing pointers to their respective locations in memory. Back buffer 103b becomes the front buffer and front buffer 103a becomes a back buffer. Subsequently, depending on the unique underlying display technology of physical display 106 and physical display 109, additional transformations may be applied. Transformations targeted to display 106 are output to display buffer 104 and transformations targeted to display 109 are output to display buffer 107. When graphical stack 101 indicates that rendering is complete, flags are checked and device driver 105 transfers data to physical display 106 and device driver 108 transfers data to physical display 109.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A process for controlling a plurality of displays from a single graphical stack, the process comprising the acts of:
a. writing frame data to a single virtual frame buffer from a single graphical stack;
b. displacing the frame data from the single virtual frame buffer to a plurality of display buffers; and
c. updating respective ones of the plurality of displays from respective ones of the plurality of display buffers.

2. The process according to claim 1, wherein a first display of the plurality of displays uses a disparate display technology from a second display of the plurality of displays.

3. The process according to claim 1, further comprising the act of calling a hook function.

4. The process according to claim 3, wherein the hook function is a hardware acceleration hook function, the process further comprising the hardware acceleration hook function setting a flag indicating at least one display of the plurality of displays does not need updating.

5. The process according to claim 4, further comprising the hardware acceleration hook function using a hardware accelerator to render the frame data received from the single graphical stack directly into a display buffer.

6. The process according to claim 1, wherein a first display of the plurality of displays is an electronic paper display.

7. The process according to claim 6, wherein a second display of the plurality of displays is a liquid crystal display.

8. The process according to claim 1, further comprising the act of checking a flag to determine whether the frame data is intended to update a first display of the plurality of displays prior to the displacing act.

9. An electronic device comprising:
a single graphical stack;
a single virtual frame buffer coupled to the single graphical stack;
a first display configured to receive data from the single virtual frame buffer; and
a second display configured to receive data from the single virtual frame buffer,
wherein the electronic device is configured to run both the first display and the second display from the single graphical stack and the single virtual frame buffer.

10. The electronic device of claim 9, wherein the electronic device is a hand-held portable device.

11. The electronic device of claim 9, wherein the first display uses a disparate display technology from the second display.

12. The electronic device of claim 9, wherein the electronic device is further configured to call a hook function.

13. The electronic device of claim 12, wherein the hook function is a hardware acceleration hook function configured to set a flag indicating the first display does not need updating.

14. The electronic device of claim 13, further comprising a hardware accelerator, wherein the hardware acceleration hook function is configured to use the hardware accelerator to render frame data received from the single graphical stack directly into a display buffer.

15. The electronic device of claim 9, wherein the first display is an electronic paper display.

16. The electronic device of claim 15, wherein the second display is a liquid crystal display.

17. The electronic device of claim 9, wherein the electronic device is further configured to check a flag to determine whether frame data is intended to update the first display prior to displacing the frame data from the virtual frame buffer into a display buffer.

18. An electronic device comprising:
a first display;
a second display;
a single graphical stack;
a single virtual frame buffer coupled to the single graphical stack;
a first display buffer coupled to the first display and configured to receive data from the single virtual frame buffer; and
a second display buffer coupled to the second display and configured to receive data from the single virtual frame buffer,
wherein the electronic device is configured to run both the first display and the second display from the single graphical stack and the single virtual frame buffer.

19. The electronic device of claim 18, wherein the first display uses a disparate display technology from the second display.

20. The electronic device of claim 18, wherein the first display is an electronic paper display and the second display is a Liquid Crystal Display.
